(19) United States
(12) Patent Application Publication
(10) Pub. No.: US 2010/0092363 A1
(43) Pub. Date: Apr. 15, 2010

(54) COMBUSTION SYNTHESIS METHOD AND MATERIALS PRODUCED THEREFROM

(76) Inventors: Olivia A. Graeve, Alfred, NY (US); Brett Pearson, Sparks, NV (US); James Tinsley, Goleta, CA (US); Wilfred Lewis, III, Santa Fe, NM (US)

Correspondence Address: UNR/DRI Technology Transfer Office, UNR-DRI Technology Transfer Office, Mail stop 321, 1664 N. Virginia St, Reno, NV, 89557, US

(21) Appl. No.: 12/559,018

(22) Filed: Sep. 14, 2009

Related U.S. Application Data
(60) Provisional application No. 61/097,066, filed on Sep. 15, 2008.

(51) Int. Cl. C01B 33/20; C01F 17/00

(52) U.S. Cl. 423/263; 423/326

(57) ABSTRACT

In various embodiments, the present disclosure provides a silicate material and a method for forming such material. According to a particular embodiment of the method, water is added to reactants including a metal salt, an oxidizer, a silicon source and a fuel source. The reactants and water are heated at a temperature between about 800° C. and about 1200° C. Heating initiates a combustion reaction and produces a nanocrystalline powder. In more particular examples of the method, the nanocrystalline powder is subsequently densified, such as by sintering. The material formed by the method is, in some cases, a lutetium-containing material suitable for use as a scintillator.

### FIELD

The present disclosure generally relates to a method for producing silicate materials. In a specific example, the present disclosure provides a method of producing finely dispersed, nanocrystalline metal silicate powders, including sintered specimens.

### BACKGROUND

A number of basic properties of scintillator materials are important for effective γ-ray detection. These properties include high detection efficiency, high light output, fast scintillation decay time, and non-hygroscopicity. LSO:Ce has a number of advantages over other scintillators. LSO:Ce has a very high detection efficiency because of its high density (7.4 g/cm³) and high effective atomic number (66) combined with a short decay time of ˜40 ns. The light yield is also very favorable, resulting in approximately 25,000 photons/MeV under 662 keV γ-ray excitation.

The use of LSO:Ce as a scintillator has been known since the beginning of the 1990's, when Melcher patented single crystals of this material for use as γ-ray detectors for nuclear physics, medical imaging, high-energy physics, and geophysics applications. More recently Chai patented the incorporation of oxygen into single crystals of this material, which enhances light yield during the scintillation process. The specifics of the preparation of the single crystals by the Czochralski technique were patented by Manente et al. in 1997 and Melcher et al. in 2002. Based on these patents, single crystals of this material are commercially available from Proteus, Inc. (located in Chagrin Falls, Ohio) and CTI Molecular Imaging Inc. (purchased by Siemens AG in 2005, located in Knoxville, Tenn.).

However, these single crystals are typically difficult to obtain and quite expensive. For example, Proteus Inc. sells single crystals of LYSO:Ce (lutetium yttrium oxyorthosilicate, 95% Lu/5% Y) with dimensions of 400 mm diameter by 400 mm in length, for $51,000. Cut pieces are not currently sold by this vendor; thus, the customer must buy the entire grown crystal and cut it to specifications. More recently a double crucible Czochralski method was developed in order to eliminate segregation problems of the cerium encountered during the typical Czochralski process, but this method is still in the research stages.

Powders of LSO:Ce can also be purchased from Phosphor Technology, Inc., but the particle size is large (˜8 μm). This size is not amenable for sintering to full density, although it has been used for producing thin porous coatings of less than 100 μm in thickness.

### SUMMARY

The present disclosure provides, among other things, a method of making a silicate. In a particular embodiment, the method includes providing reactants comprising a metal salt, an oxidizer, a silicon source, and a fuel source. Water is added to the reactants. In some implementations, the reactants are heated at a temperature between about 700° C. and about 1,600° C., such as between about 800° C. and about 1200° C., between about 900° C. and about 1,200° C., or between about 800° C. and about 1,000° C. to initiate a combustion reaction and produce a nanocrystalline powder.

In further embodiments, the method includes a densification step, such as using a sintering procedure. In a particular implementation, powders produced using the above-described reaction are pressed into green compacts and sintered in a high-temperature furnace ranging between 1,500° C. and about 2,150° C., such as about 1,750° C. to about 2,050° C., or about 1,800° C. to about 2,000° C., such as for between 2 and about 12 hours. In some examples, the sintering step includes pressureless sintering, such as in an atmosphere having an oxygen partial pressure of between about 10⁻⁹ atmospheres and about 10⁻¹³ atmospheres. In other examples, sintering is carried out at atmospheric pressure.

Prior to sintering, the material can be subjected to other steps, such as vibratory packing or annealing, such as at a temperature of between about 500° C. and about 1000° C.

Some embodiments of the disclosed method include irradiating a material produced using an above-described method with γ-rays.

The present disclosure also provides materials produced by the above-described method. In some examples, the materials are used in detectors. The present disclosure also provides instruments including such detectors.

There are additional features and advantages of the various embodiments of the present disclosure. They will become evident as this specification proceeds.

In this regard, it is to be understood that this is a brief summary of the various embodiments described herein. Any given embodiment of the present disclosure need not provide all features noted above, nor must it solve all problems or address all issues in the prior art noted above.

### BRIEF DESCRIPTION OF THE DRAWINGS

FIG. 1 is flowchart of a method of synthesizing and densifying LSO:Ce according to an embodiment of the present disclosure.

FIG. 2 is x-ray diffraction data for LSO:Ce powders prepared according to the method of FIG. 1.

FIG. 3 is a dynamic light scattering data for LSO:Ce powders prepared according to the method of FIG. 1.

FIG. 4 is photoluminescence spectra for LSO:Ce prepared according to an embodiment of the present disclosure for samples where a post synthesis heat treatment was initiated at 500° C., 750° C., and 1000° C.

FIG. 5 is a graph of temperature and pressure versus time for a sintering run of LSO:Ce prepared according to the method of FIG. 1.

FIG. 6 illustrates the size, packing conditions, and sintering support for three samples used in the sintering run of FIG. 5.

FIG. 7 is a photograph of a LSO:Ce disc produced using the method of FIG. 1 that is backlit to show the material's translucence.

FIG. 8 is a photograph of a LSO:Ce disc produced using the method of FIG. 1 showing the material's response to γ-rays.

### DETAILED DESCRIPTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together. All numerical ranges given herein include all values, including end points (unless specifically excluded) and any and all intermediate ranges between the endpoints.

Although methods and materials similar or equivalent to those described herein can be used in the practice or testing of the present disclosure, suitable methods and materials are described herein. The disclosed materials, methods, and examples are illustrative only and not intended to be limiting.

The ease of manufacture and ultimate performance of advanced materials typically depend on the properties of the starting powders used during processing. Generally, powders that are free-flowing and of higher purity are desirable. The present disclosure provides a method of producing such powders, including powders having nanocrystalline or sub-micron particles. The powders can be further processed to produce materials of interest, such as by sintering the powders to produce denser materials. In particular examples, the powders are sufficiently nanocrystalline and of sufficiently small size to allow full densification by sintering or another densification technique.

Combustion synthesis is a wet chemical precipitation-type process in which an exothermic reaction occurs between precursor components, such as a metal species, oxidizer, and fuel. In some cases, the oxidizer is part of the metal species. Combustion synthesis typically involves initiating reaction between the precursor components by heating the precursor components at a temperature sufficient to initiate a reaction between the fuel and oxidizer. The reaction produces gaseous products and can be designed such that the products contain the desired voluminous material and gases that escape during the reaction. For example, proper selection of reaction conditions can allow gaseous products to carry heat away from the system, hinder particle growth, and allow the synthesis of powders with crystallites, such as crystallites of nanometer dimensions. The gases produced by the reaction can increase the surface area of the powders, such as by creating micro- and nano-porous regions within the reaction zone.

According to an embodiment of the present disclosure, nanostructured powders, optionally containing a dopant, are prepared using combustion synthesis. When a dopant is used and the oxidizer is part of a metallic precursor, the reaction can be represented by the following equation:

$$M + N + {SiO}_{x} + Fuel {}^{{H}_{2} O} {M SiO}_{x} \text{:} N + {CO}_{2} + {H}_{2} O + A + B \qquad ( 1 )$$

Where M and N are metal species having anions that can act as an oxidizer, such as nitrate, SiOₓ is a silicon compound, and the fuel is, in some examples, a carbonaceous fuel, such as carbohydrazide, glycine, urea, or mixtures thereof. In some examples, the silicon compound is an amorphous silicon compound, such as fumed silica. While silica is used in some examples, in other examples the silicon compound is a silicate, such as a ternary oxide. The reaction produces a metal silicate of M doped with N. The reaction also produces carbon dioxide, water, and redox products A and B. In a particular example, the oxidizer is nitrate included as the metal anion in M and N, in which case A and B are nitrogen and oxygen, respectively.

In a more specific example, the disclosed method is used to produce LSO:Ce. In this case, in equation (1) M is a hydrate of Lu(NO₃)₃, N is a hydrate of Ce(NO₃)₃, and SiOₓ, is SiO₂, in which case equation (1) becomes:

$${Lu ( {NO}_{3} )}_{3} \cdot 4 {H}_{2} O + x \cdot {Ce ( {NO}_{3} )}_{3} \cdot 6 {H}_{2} O + {SiO}_{2} + Fuel {}^{{H}_{2} O} {Lu}_{2 - x} {Ce}_{x} {SiO}_{5} + a \cdot {CO}_{2} + b \cdot {H}_{2} O + c \cdot {N}_{2} \qquad ( 2 )$$

The type of fuel and the fuel-to-oxidizer ratio are two parameters for determining the reaction temperature reached during combustion. Typically, higher fuel-to-oxidizer ratios (greater amounts of fuel) produce higher reaction temperatures. In some examples, the fuel-to-oxidizer molar ratio is from about 1:1 to about 8:1, more typically from about 1.2:1 to about 4:1.

Once initiated, the reaction of the precursor reactants is exothermic. In particular examples, the temperature of the combustion reaction reaches a temperature of between about 1,000 K and about 3,000 K. The reaction typically completes quickly, such as with a velocity of between about 1 mm/s and about 100 mm/s based on the surface area of the reactants. In a typical combustion reaction, the precursor mixture, which is diluted in a small amount of water and placed in a low-temperature muffle furnace, dehydrates and ruptures into flame in less than five minutes.

The reaction temperature can also be influenced by the atmosphere in which the reaction occurs.

In a particular example, synthesis is carried out using carbohydrazide (CH₆N₄O) as a fuel. Compared with other fuels, carbohydrazide can have more desirable features, including a high reaction temperature. Carbohydrazide can also complex with metal cations, thereby increasing their solubility and helping avoid selective precipitation from occurring as water is evaporated during the reaction. The carbohydrazide molecule has two amine groups, both of which are available to complex metal ions.

The dopant is typically present in the metal silicate product in amount between about 0.01% and about 99% by molar weight. In some examples, such as when the disclosed method is used to produce scintillator materials, such as LSO:Ce, the dopant is more typically present in an amount between about 0.01% by molar weight and about 5% by molar weight or between about 0.075% by molar weight and about 1% by molar weight or, in a specific example, about 0.1% by molar weight.

The combustion reaction is typically initiated by heating the reactants, such as by placing the precursor materials in a furnace, such as a muffle furnace. At least in some implementations of the disclosed method, such as when used to form metal silicates, it has been found that desirable products are produced using higher initiation temperatures than have typically been used for composition synthesis. Typically, combustion synthesis is initiated at a temperature of about 500° C. or less. In some examples, such as when the disclosed method is used to produce LSO:Ce, the reactants are heated at a temperature between about 700° C. and about 1,600° C., such as between about 800° C. and about 1200° C., between about 900° C. and about 1,200° C., or between about 800° C. and about 1,000° C. In a specific example, the reactants are heated at a temperature of about 1,000° C. When producing emissive materials, it has been found that, in some cases, heating the reactants at comparatively higher temperatures can produce powders having higher emission intensities.

Powders obtained by the disclosed method are typically nanocrystalline and lightly agglomerated, such as particles suitable for densification by pressureless sintering. In some examples, the powders have nanocrystalline particles, such as particles having an average cross-sectional width of less than about 100 nm, about 70 nm, about 40 nm, or about 30 nm. In further examples, the nanocrystalline particles have an average cross-sectional width of between about 20 nm and about 65 nm or about 25 nm and about 45 nm. In further example, agglomerates of the nanocrystalline particles have an average cross-sectional width of less than about 8 μm, such as less than about 7 μm, about 6 μm, about 5 μm, about 4 μm, about 3 μm, or about 2 μm. In other examples, the agglomerates have an average cross sectional width between about 1 μm and about 7 μm, such as between about 2 μm and about 5 μm or between about 3 μm and about 4 μm.

In some cases, the powders are subject to further processing to produce materials of interest, such as using a densification procedure to increase the density of the material. For example, the powders can be annealed, such as to produce more dense structures. In some examples, annealing is carried out at a temperature of between about 400° C. and about 1200° C., such as between about 500° C. and about 1000° C.

In some examples, it may be desirable to eliminate as much porosity as practicable from the material before carrying out additional densifying treatments. For example, prior to sintering, the powders can be treated, such as by grinding. The powders can also, for example, be packed, such as using vibratory packing, to help provide an even distribution of material during sintering and to help provide a product having a desired density. In some cases, the powders are pressed to form green compacts which are subsequently densified, such as by sintering.

Sintering, including sintering of previously annealed materials, is typically carried out at a temperature of between about 1,500° C. and about 2,150° C., such as about 1,750° C. to about 2,050° C., or about 1,800° C. to about 2,000° C. In a specific example, the material is sintered at about 2,000° C. using pressureless sintering, which can help reduce density variations in the final product. In some examples of pressureless sintering, sintering is performed under high vacuum, such as about 10⁻⁴ torr to about 10⁻⁶ torr, such as about 10⁻⁵ ton. In another example, the material is sintered at about 1,650° C., for example, in 1 atmosphere of oxygen to maintain the silica content.

In addition to the final sintering temperature and the sintering pressure, sintering can be affected by a number of other parameters. For example, the rate at which the material is brought to the sintering temperature, or subsequently cooled, can affect the properties of the resulting material. In a particular example, a LSO:Ce material is heated at rate of about 5° C./minute until the maximum temperature is reached, held at the maximum temperature for a period of time, which can range from about 2 hours to 12 hours, and then cooled at a rate of about 10° C./minute. In another example both the heating rate and cooling rates are about 5° C./minute The time the material is held at the sintering temperature can also influence the product's properties. In one example, the material is held at the maximum sintering temperature for about four hours. The sintering time and other parameters can be affected by various properties of the starting material, such as the particle size or thickness of material, or desired final product, such as the desired final density.

The composition of the sintering atmosphere can also influence product properties. In some examples, the oxygen content of the sintering atmosphere is controlled to reduce the loss of silicon from the sintered material or to reduce the formation of silicon dioxide. In some examples, the oxygen concentration is such that the atmosphere has an oxygen partial pressure of between about 10⁻¹ and about 10⁻¹⁴ atmospheres, more typically between about 10⁻⁸ and about 10⁻¹³ atmospheres or between about 10⁻¹¹ and about 10⁻¹² atmospheres. In other particular examples the oxygen concentration can be as high as about 1 atm. In at least some examples, higher oxygen pressures can improve silica retention in the final product.

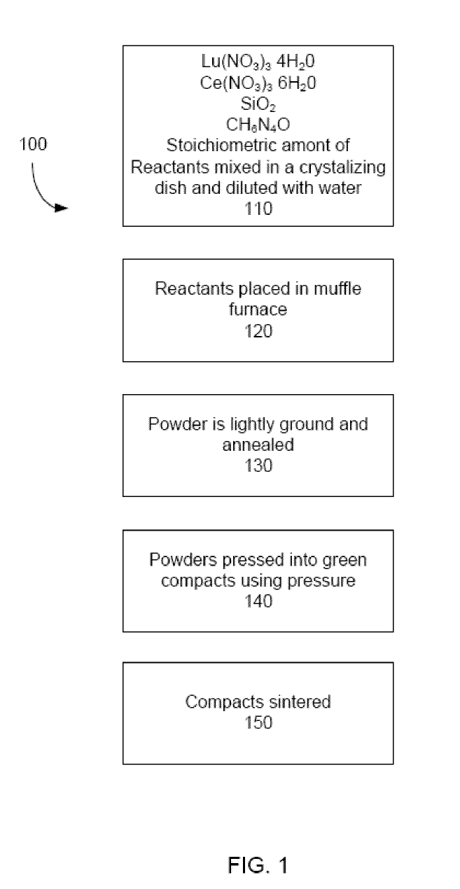

FIG. 1 illustrates the steps of one embodiment of a disclosed method 100 for producing LSO:Ce powders. In step 110, the precursor materials, after weighing as per the stoichiometric relation, are placed in a crystallizing dish and dissolved in water. In step 120, the reactants are placed in a muffle furnace and heated at a temperature of 1000° C. In step 130, the resulting powder is lightly ground and then annealed. Interestingly, when crystalline silica was used in the reaction of FIG. 1, LSO:Ce was not produced. Instead, the reaction formed Lu₂O₃ and SiO₂. In step 140 the powders are pressed to form green compacts in preparation for sintering. In step 150 the compacts are placed in a high-temperature furnace for sintering to complete the densification process.

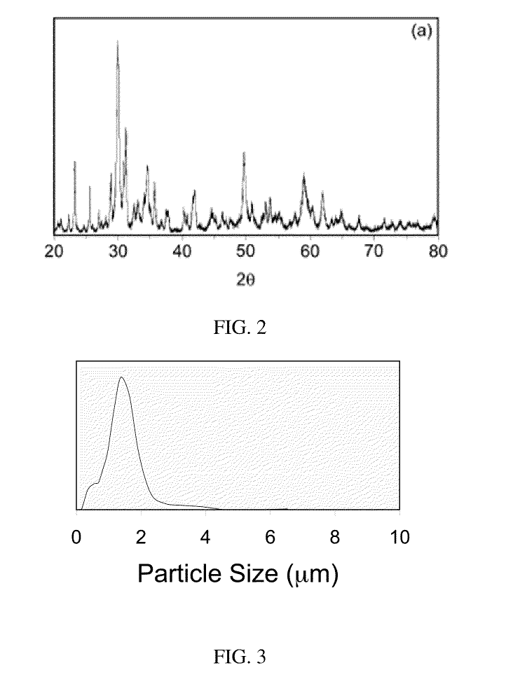

X-ray diffraction data for material formed by the process of FIG. 1 is shown in FIG. 2. FIG. 2 demonstrates that the crystallite size of the powders is about 30 nm. Dynamic light scattering data is shown in FIG. 3 and demonstrates that the particle size of the material is about 2 μm. No known LSO:Ce powders are commercially available that are so fine and well-dispersed.

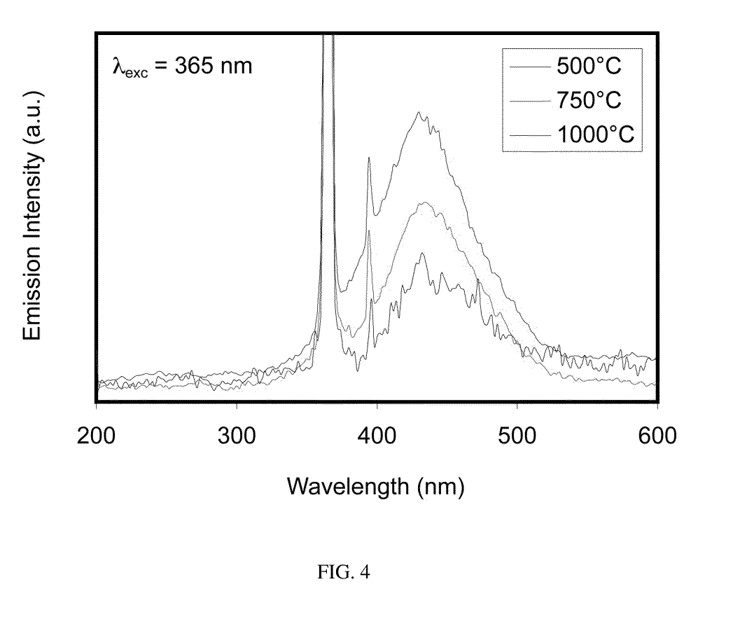

The method of FIG. 1 was repeated, changing the temperature of annealing between 500° C., 750° C., and 1000° C. FIG. 4 illustrates photoluminescence spectra for the three materials. Materials became progressively more emissive as the heat-treatment temperature was increased.

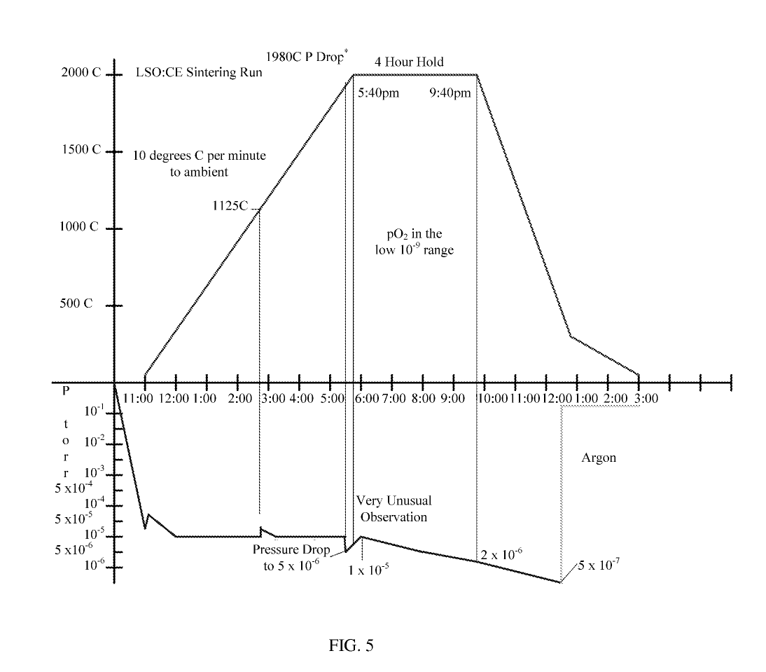

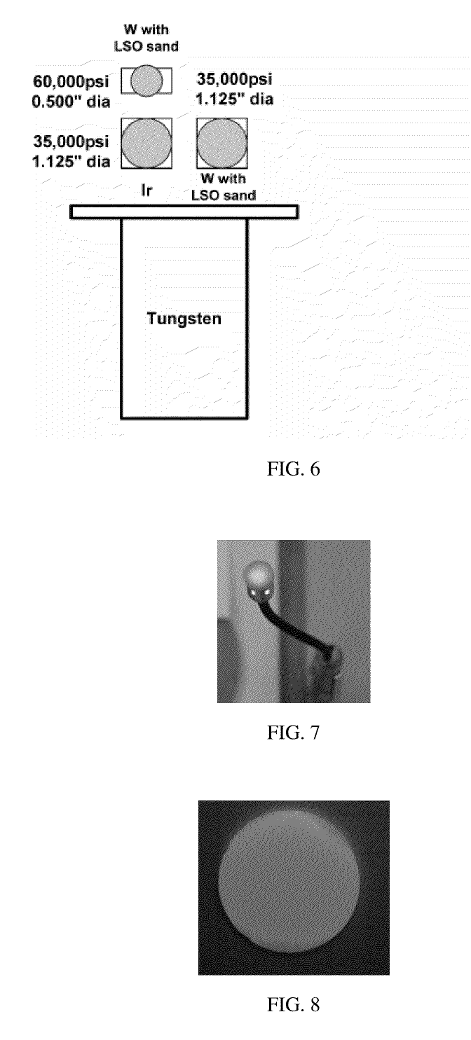

FIG. 5 presents a graph (temperature, upper axis, and pressure, lower axis, versus time) for a sintering process using material produced from the method of FIG. 1. Three samples, summarized in FIG. 6, were sintered. The dimensions are the sizes of the initial specimens (before sintering) and the pressure represents the vibratory packing pressure. The sample on top was sintered over tungsten and on top of LSO sand, the lower left sample was sintered over iridium, and the lower right sample with sintered over tungsten on top of LSO sand.

Referring back to FIG. 5, it can be seen that the temperature was gradually increased until the maximum sintering temperature of 2000° C. was reached. The material was held at this temperature and then gradually cooled to ambient temperature.

FIG. 7 illustrates a backlit sintered disk of LSO:Ce material produced according to the method of FIG. 1, demonstrating that the material was translucent. FIG. 8 illustrates the luminescence of a sintered disk of LSO:Ce material produced according to the method of FIG. 1 in response to γ-rays.

Materials that can be produced using the disclosed method may find a number of uses. The LSO:Ce γ-ray detectors offer attractive applications in both military and civilian applications, and particularly in the harsh environments encountered in military applications. National security applications include homeland security, forensics, and local state and federal responders to a possible radiation incident. In particular, LSO:Ce produced by the disclosed method may find use in the fabrication of detectors for nuclear, biological and chemical agents. In addition to the national security applications, they can also be applied to medical imaging, physics experiments, and radiation contamination mapping.

It is to be understood that the above discussion provides a detailed description of various embodiments. The above descriptions will enable those of ordinary skill in the art to make and use the disclosed embodiments, and to make departures from the particular examples described above to provide embodiments of the methods and apparatuses constructed in accordance with the present disclosure. The embodiments are illustrative, and not intended to limit the scope of the present disclosure. The scope of the present disclosure is rather to be determined by the scope of the claims as issued and equivalents thereto.

1. A method of making a silicate material, comprising:
providing reactants comprising a metal salt, an oxidizer, a silicon source, and a fuel source;
adding water to the reactants; and
heating the reactants at a temperature between 800° C. and about 1200° C. to initiate a combustion reaction and produce a nanocrystalline powder.

2. The method of claim 1, wherein the fuel source comprises a carbonaceous fuel source.

3. The method of claim 1, wherein the fuel source comprises carbohydrazide.

4. The method of claim 1, wherein the metal salt comprises Lu(NO₃)₃.

5. The method of claim 1, wherein the reactants further comprise a dopant comprising Ce(NO₃)₃.

6. The method of claim 1, wherein heating the reactants comprises heating the reactants at a temperature of between about 900° C. and about 1100° C.

7. The method of claim 1, wherein the silicon source comprises amorphous silica.

8. The method of claim 1, wherein the silicon source comprises fumed silica.

9. The method of claim 1, wherein the silica source comprises amorphous silica, the metal salt comprises Lu(NO₃)₃, the fuel source comprises a carbonaceous fuel source, and the reactants further comprise a dopant comprising Ce(NO₃)₃.

10. The method of claim 1, wherein the metal salt comprises a metal nitrate and the oxidizer comprises the nitrate of the metal salt.

11. The method of claim 10, wherein the reactants further comprise a dopant comprising a metal nitrate and wherein the oxidizer comprises the nitrate of the dopant.

12-21. (canceled)
